(19) United States
(12) Patent Application Publication
(10) Pub. No.: US 2025/0294566 A1
(43) Pub. Date: Sep. 18, 2025

(54) METHOD OF PUSCH TRANSMISSION WITH THREE TRANSMIT PORTS AND USER EQUIPMENT

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 19/221,157

(22) Filed: May 28, 2025

Related U.S. Application Data
(63) Continuation of application No. PCT/CN2024/070557, filed on Jan. 4, 2024.
(60) Provisional application No. 63/479,702, filed on Jan. 12, 2023.

(51) Int. Cl. H04W 72/21; H04B 7/0404; H04B 7/0456

(52) U.S. Cl. CPC H04W 72/21; H04B 7/0404; H04B 7/0456

(57) ABSTRACT

A method of physical uplink shared channel (PUSCH) transmission with three transmit ports, by a user equipment (UE) includes reporting to a base station that the UE supports three transmit ports for one PUSCH transmission and being configured by the base station with the one PUSCH transmission with the three transmit ports.

### CROSS REFERENCE TO RELATED APPLICATION(S)

This application is a continuation of International Application No. PCT/CN2024/070557, filed Jan. 4, 2024, which claims priority to U.S. Provisional Application No. 63/479,702, filed Jan. 12, 2023, the entire disclosures of which are incorporated herein by reference.

### TECHNICAL FIELD

The present disclosure relates to the field of communication systems, and more particularly, to methods of physical uplink shared channel (PUSCH) transmission with three transmit ports and a user equipment (UE).

### BACKGROUND

The current physical uplink shared channel (PUSCH) transmission design does not support a user equipment (UE) with three transmit ports. For the UE with the three transmit ports, the current supported PUSCH mechanism can only either configure one PUSCH transmission with two transmit ports, or configure one PUSCH transmission with four transmit ports but only applying a precoding matrix that has zero value in the last term. All those implementation methods based on the current PUSCH mechanism would greatly impair a performance of uplink transmission.

Therefore, there is a need for apparatuses and methods of physical uplink shared channel (PUSCH) transmission with three transmit ports.

### SUMMARY

In a first aspect of the present disclosure, a method of physical uplink shared channel (PUSCH) transmission with three transmit ports, by a user equipment (UE) includes reporting to a base station that the UE supports three transmit ports for one PUSCH transmission; and being configured by the base station with the one PUSCH transmission with the three transmit ports.

In a second aspect of the present disclosure, a method of physical uplink shared channel (PUSCH) transmission with three transmit ports, by a base station includes being reported by a user equipment (UE) that the UE supports three transmit ports for one PUSCH transmission and configuring, to the UE, the one PUSCH transmission with the three transmit ports.

In a third aspect of the present disclosure, a UE includes a memory, a transceiver, and a processor coupled to the memory and the transceiver. The UE is configured to perform the method in the first aspect.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of one or more user equipments (UEs) and a base station of communication in a communication network system according to an embodiment of the present disclosure.

FIG. 2 is a block diagram of a UE according to an embodiment of the present disclosure.

FIG. 3 is a block diagram of a UE according to an embodiment of the present disclosure.

FIG. 4 is a flowchart illustrating a method of physical uplink shared channel (PUSCH) transmission with three transmit ports performed by a UE according to an embodiment of the present disclosure.

FIG. 5 is a block diagram of a base station according to an embodiment of the present disclosure.

FIG. 6 is a block diagram of a base station according to an embodiment of the present disclosure.

FIG. 7 is a flowchart illustrating a method of physical uplink shared channel (PUSCH) transmission with three transmit ports performed by a base station according to an embodiment of the present disclosure.

FIG. 8 is a block diagram of an example of a computing device according to an embodiment of the present disclosure.

FIG. 9 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved PLMN, etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

A new radio (NR) system supports physical uplink shared channel (PUSCH) transmission in uplink. The PUSCH transmission supports 1 port transmission, 2 port transmission, and 4 port transmission. When a UE is configured with 2 ports or 4 ports, a base station such as gNB can indicate the UE to apply precoding matrix on PUSCH transmission. For a UE with 2 ports, the gNB can request the UE to transmit a PUSCH with one layer or two layers. For a PUSCH with one layer, the gNB can request the UE to apply one of the following transmit precoding matrices on PUSCH transmission:

| TPMI | W | | | | | | | |
|---|---|---|---|---|---|---|---|---|
| index | (ordered from left to right in increasing order of transmit precoding matrix indication | | | | | | | |
| | (TPMI) index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

For a UE with 2 ports and for a PUSCH with two layers, the gNB can request the UE to apply one of the following transmit precoding matrices on PUSCH transmission:

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

For a UE with 4 ports, the gNB can request the UE to transmit a PUSCH with one layer, two layers, three layers, or four layers. For a PUSCH with one layer, the gNB can request the UE to apply one of the following transmit precoding matrices on PUSCH transmission:

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

For a PUSCH with two layers, the gNB can request the UE to apply one of the following transmit precoding matrices on PUSCH transmission:

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

For a PUSCH with three layers, the gNB can request the UE to apply one of the following transmit precoding matrices on PUSCH transmission:

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

For a PUSCH with four layers, the gNB can request the UE to apply one of the following transmit precoding matrices on PUSCH transmission:

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

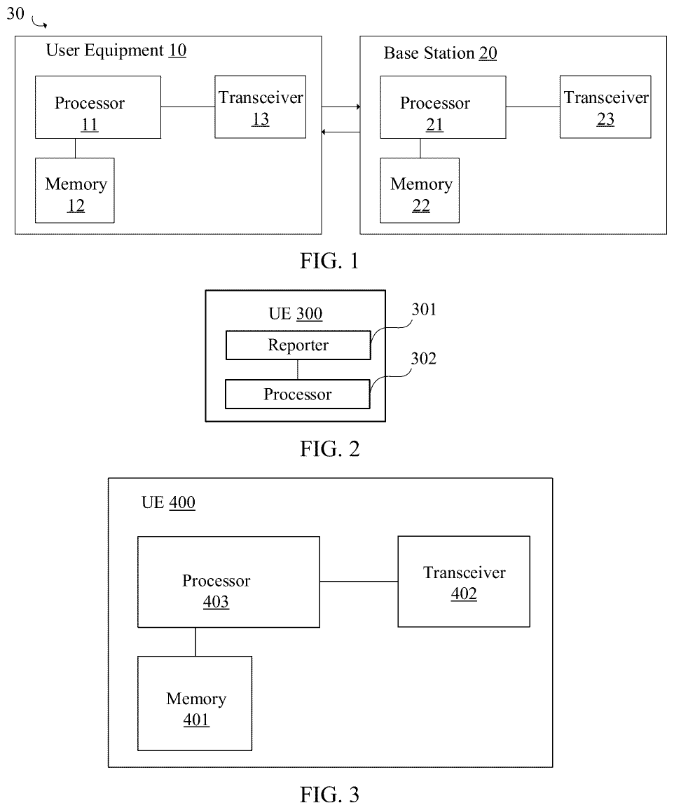

FIG. 1 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the UE 10 is configured to report to the base station 20 that the UE 10 supports three transmit ports for one PUSCH transmission, and the UE 10 is configured by the base station 20 with the one PUSCH transmission with the three transmit ports. This can solve issues in the prior art and other issues, support PUSCH transmission with three transmit ports, and/or improve a performance of uplink transmission.

In some embodiments, the base station 20 is reported by the UE 10 that the UE 10 supports three transmit ports for one PUSCH transmission and the base station 20 is configured to configure, to the UE 10, the one PUSCH transmission with the three transmit ports. This can solve issues in the prior art and other issues, support PUSCH transmission with three transmit ports, and/or improve a performance of uplink transmission.

FIG. 2 illustrates an example of a UE 300 according to an embodiment of the present application. The UE 300 is configured to implement some embodiments of the disclosure. Some embodiments of the disclosure may be implemented into the UE 300 using any suitably configured hardware and/or software. The UE 300 includes a reporter 301 configured to report to a base station that the UE 300 supports three transmit ports for one PUSCH transmission and a processor 302 being configured by the base station with the one PUSCH transmission with the three transmit ports. This can solve issues in the prior art and other issues, support PUSCH transmission with three transmit ports, and/or improve a performance of uplink transmission.

FIG. 3 illustrates an example of a UE 400 according to an embodiment of the present disclosure. The UE 400 is configured to implement some embodiments of the disclosure. Some embodiments of the disclosure may be implemented into the UE 400 using any suitably configured hardware and/or software. The UE 400 may include a memory 401, a transceiver 402, and a processor 403 coupled to the memory 401 and the transceiver 402. The processor 403 may be configured to implement proposed functions, procedures and/or methods described in this description. Layers of radio interface protocol may be implemented in the processor 403. The memory 401 is operatively coupled with the processor 303 and stores a variety of information to operate the processor 403. The transceiver 402 is operatively coupled with the processor 403, and the transceiver 402 transmits and/or receives a radio signal. The processor 403 may include application-specific integrated circuit (ASIC), other chipset, logic circuit and/or data processing device. The memory 401 may include read-only memory (ROM), random access memory (RAM), flash memory, memory card, storage medium and/or other storage device. The transceiver 402 may include baseband circuitry to process radio frequency signals. When the embodiments are implemented in software, the techniques described herein can be implemented with modules (e.g., procedures, functions, and so on) that perform the functions described herein. The modules can be stored in the memory 401 and executed by the processor 403. The memory 401 can be implemented within the processor 403 or external to the processor 403 in which case those can be communicatively coupled to the processor 403 via various means as is known in the art.

In some embodiments, the UE 400 is configured to report to a base station that the UE 400 supports three transmit ports for one PUSCH transmission, and the UE 400 is configured by the base station with the one PUSCH transmission with the three transmit ports. This can solve issues in the prior art and other issues, support PUSCH transmission with three transmit ports, and/or improve a performance of uplink transmission.

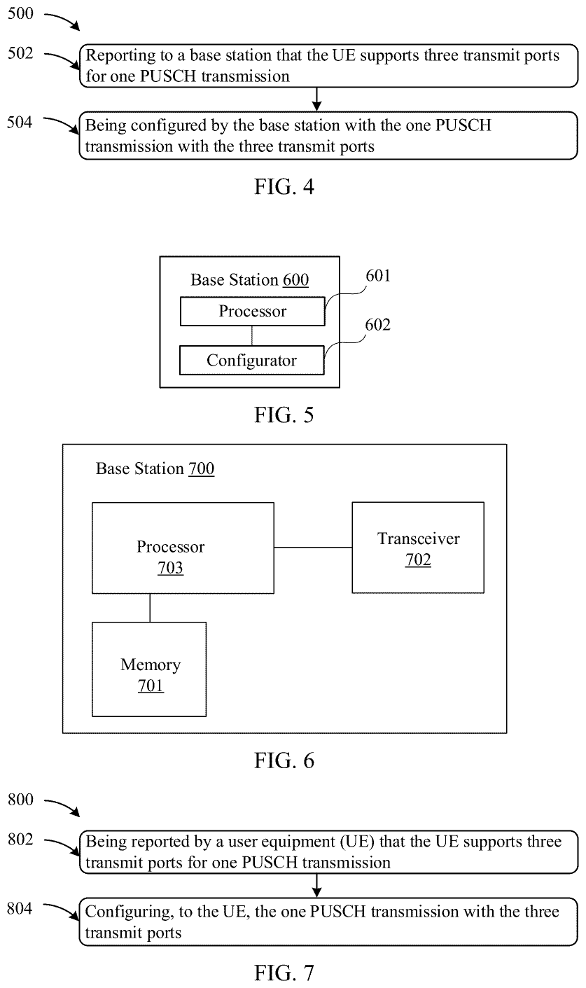

FIG. 4 is an example of a method 500 of physical uplink shared channel (PUSCH) transmission with three transmit ports performed by a UE according to an embodiment of the present disclosure. The method 500 of physical uplink shared channel (PUSCH) transmission with three transmit ports performed by a UE is configured to implement some embodiments of the disclosure. Some embodiments of the disclosure may be implemented into the method 500 of physical uplink shared channel (PUSCH) transmission with three transmit ports performed by a

UE using any suitably configured hardware and/or software. In some embodiments, the method 500 of physical uplink shared channel (PUSCH) transmission with three transmit ports performed by a UE includes: an operation 502, reporting to a base station that the UE supports three transmit ports for one PUSCH transmission, and an operation 504, being configured by the base station with the one PUSCH transmission with the three transmit ports. This can solve issues in the prior art and other issues, support PUSCH transmission with three transmit ports, and/or improve a performance of uplink transmission.

In some embodiments, reporting to the base station that the UE supports the three transmit ports for the one PUSCH transmission includes reporting to the base station in a UE capability reporting message that the UE supports the three transmit ports for the one PUSCH transmission. In some embodiments, the method further includes being indicated by the base station to transmit the one PUSCH transmission with the three transmit ports. In some embodiments, being indicated by the base station to transmit the one PUSCH transmission with the three transmit ports includes being indicated by the base station through a downlink control information (DCI) to transmit the one PUSCH transmission with the three transmit ports. In some embodiments, the method further includes being indicated by the base station with a number of layers for the one PUSCH transmission with the three transmit ports. In some embodiments, the number of layers is one layer, two layers, or three layers. In some embodiments, the method further includes being indicated by the base station with at least one transmit precoding matrix for the one PUSCH transmission with the three transmit ports.

In some embodiments, the UE is indicated to transmit the one PUSCH transmission with the three transmit ports, the one layer, and one of transmit precoding matrixes in a table 1:

TABLE 1

| TPMI | | | | | | | | |
|---|---|---|---|---|---|---|---|---|
| index | W | | | | | | | |
| 0-7 | $\frac{1}{\sqrt{3}} [ \begin{matrix}1 \\ 0 \\ 0\end{matrix} ]$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ | $\frac{1}{\sqrt{3}} [ \begin{matrix}1 \\ 1 \\ 0\end{matrix} ]$ | $\frac{1}{\sqrt{3}} [ \begin{matrix}1 \\ - 1 \\ 0\end{matrix} ]$ | $\frac{1}{\sqrt{3}} [ \begin{matrix}1 \\ j \\ 0\end{matrix} ]$ | $\frac{1}{\sqrt{3}} [ \begin{matrix}1 \\ - j \\ 0\end{matrix} ]$ | $\frac{1}{\sqrt{3}} [ \begin{matrix}1 \\ 0 \\ 1\end{matrix} ]$ |
| 8-15 | $\frac{1}{\sqrt{3}} [ \begin{matrix}1 \\ 0 \\ - 1\end{matrix} ]$ | $\frac{1}{\sqrt{3}} [ \begin{matrix}1 \\ 0 \\ - j\end{matrix} ]$ | $\frac{1}{\sqrt{3}} [ \begin{matrix}1 \\ 0 \\ j\end{matrix} ]$ | $\frac{1}{\sqrt{3}} [ \begin{matrix}1 \\ 1 \\ 1\end{matrix} ]$ | $\frac{1}{\sqrt{3}} [ \begin{matrix}1 \\ {e}^{- \frac{2 π j}{3}} \\ {e}^{- \frac{4 π j}{3}}\end{matrix} ]$ | $\frac{1}{\sqrt{3}} [ \begin{matrix}1 \\ {e}^{- \frac{4 π j}{3}} \\ {e}^{- \frac{8 π j}{3}}\end{matrix} ]$ | $\frac{1}{\sqrt{3}} [ \begin{matrix}1 \\ {e}^{\frac{2 π j}{3}} \\ 1\end{matrix} ]$ | $\frac{1}{\sqrt{3}} [ \begin{matrix}1 \\ 1 \\ {e}^{- \text{?}}\end{matrix} ]$ |
| 16-19 | $\frac{1}{\sqrt{3}} [ \begin{matrix}1 \\ {e}^{- \frac{2 π j}{3}} \\ {e}^{- \frac{8 π j}{3}}\end{matrix} ]$ | $\frac{1}{\sqrt{3}} [ \begin{matrix}1 \\ 1 \\ {e}^{\frac{2 π j}{3}}\end{matrix} ]$ | $\frac{1}{\sqrt{3}} [ \begin{matrix}1 \\ {e}^{- \frac{2 π j}{3}} \\ {e}^{- \frac{2 π j}{3}}\end{matrix} ]$ | $\frac{1}{\sqrt{3}} [ \begin{matrix}1 \\ {e}^{- \frac{4 π j}{3}} \\ 1\end{matrix} ]$ | | | | |

$\text{?} \text{indicates text missing or illegible when filed}$

wherein W is an order from left to right in an increasing order of a transmit precoding matrix

In some embodiments, the UE is indicated to transmit the one PUSCH transmission with the three transmit ports, the one layer, and one of transmit precoding matrixes in a table 2:

TABLE 2

| TPMI | | | | |
|---|---|---|---|---|
| index | W | | | |
| 0-3 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ | $\frac{1}{\sqrt{3}} [ \begin{matrix}1 & 0 \\ 0 & j \\ 0 & 0\end{matrix} ]$ |
| 4-7 | $\frac{1}{\sqrt{3}} [ \begin{matrix}1 & 0 \\ 0 & 0 \\ 0 & j\end{matrix} ]$ | $\frac{1}{\sqrt{3}} [ \begin{matrix}0 & 0 \\ 1 & 0 \\ 0 & j\end{matrix} ]$ | $\frac{1}{\sqrt{3}} [ \begin{matrix}1 & 0 \\ 0 & - j \\ 0 & 0\end{matrix} ]$ | $\frac{1}{\sqrt{3}} [ \begin{matrix}1 & 0 \\ 0 & 0 \\ 0 & - j\end{matrix} ]$ |
| 8-11 | $\frac{1}{\sqrt{3}} [ \begin{matrix}0 & 0 \\ 1 & 0 \\ 0 & - j\end{matrix} ]$ | $\frac{1}{\sqrt{6}} [ \begin{matrix}1 & 1 \\ 1 & {e}^{- \frac{2 π j}{3}} \\ 1 & {e}^{- \frac{4 π j}{3}}\end{matrix} ]$ | $\frac{1}{\sqrt{6}} [ \begin{matrix}1 & 1 \\ 1 & {e}^{- \frac{4 π j}{3}} \\ 1 & {e}^{- \frac{8 π j}{3}}\end{matrix} ]$ | $\frac{1}{\sqrt{6}} [ \begin{matrix}1 & 1 \\ {e}^{- \frac{2 π j}{3}} & {e}^{- \frac{4 π j}{3}} \\ {e}^{- \frac{4 π j}{3}} & {e}^{- \frac{8 π j}{3}}\end{matrix} ]$ |
| 12-15 | $\frac{1}{\sqrt{6}} [ \begin{matrix}1 & 1 \\ {e}^{\frac{2 π j}{3}} & 1 \\ 1 & {e}^{\frac{4 π j}{3}}\end{matrix} ]$ | $\frac{1}{\sqrt{6}} [ \begin{matrix}1 & 1 \\ {e}^{\frac{2 π j}{3}} & {e}^{- \frac{2 π j}{3}} \\ 1 & {e}^{- \frac{8 π j}{3}}\end{matrix} ]$ | $\frac{1}{\sqrt{6}} [ \begin{matrix}1 & 1 \\ 1 & {e}^{- \frac{2 π j}{3}} \\ {e}^{\frac{4 π j}{3}} & {e}^{- \frac{8 π j}{3}}\end{matrix} ]$ | $\frac{1}{\sqrt{6}} [ \begin{matrix}1 & 1 \\ 1 & {e}^{- \frac{2 π j}{3}} \\ {e}^{\frac{2 π j}{3}} & {e}^{- \frac{2 π j}{3}}\end{matrix} ]$ |
| 16-17 | $\frac{1}{\sqrt{6}} [ \begin{matrix}1 & 1 \\ 1 & {e}^{- \frac{4 π j}{3}} \\ {e}^{\frac{2 π j}{3}} & 1\end{matrix} ]$ | $\frac{1}{\sqrt{6}} [ \begin{matrix}1 & 1 \\ {e}^{- \frac{2 π j}{3}} & {e}^{- \frac{4 π j}{3}} \\ {e}^{- \frac{2 π j}{3}} & 1\end{matrix} ]$ | | |

wherein W is an order from left to right in an increasing order of a transmit precoding matrix

In some embodiments, the UE is indicated to transmit the one PUSCH transmission with the three transmit ports, the one layer, and one of transmit precoding matrixes in a table 3:

TABLE 3

| TPMI | W | | |
|---|---|---|---|
| index | | | |
| 0-2 | $\frac{1}{3} [ \begin{matrix}1 & 1 & 1 \\ 1 & {e}^{- \frac{2 π j}{3}} & {e}^{- \frac{4 π j}{3}} \\ 1 & {e}^{- \frac{4 π j}{3}} & {e}^{- \frac{8 π j}{3}}\end{matrix} ]$ | $\frac{1}{3} [ \begin{matrix}1 & 1 & 1 \\ {e}^{\frac{2 π j}{3}} & 1 & {e}^{- \frac{2 π j}{3}} \\ 1 & {e}^{- \frac{4 π j}{3}} & {e}^{- \frac{8 π j}{3}}\end{matrix} ]$ | $\frac{1}{3} [ \begin{matrix}1 & 1 & 1 \\ 1 & {e}^{- \frac{2 π j}{3}} & {e}^{- \frac{4 π j}{3}} \\ {e}^{\frac{2 π j}{3}} & {e}^{- \frac{2 π j}{3}} & 1\end{matrix} ]$ |

wherein W is an order from left to right in an increasing order of a transmit precoding matrix

FIG. 5 illustrates an example of base station 600 according to an embodiment of the present application. The base station 600 is configured to implement some embodiments of the disclosure. Some embodiments of the disclosure may be implemented into the base station 600 using any suitably configured hardware and/or software. The base station 600 includes a processor 601 being reported by a user equipment (UE) that the UE supports three transmit ports for one PUSCH transmission and a configurator 602 configured to configure, to the UE, the one PUSCH transmission with the three transmit ports. This can solve issues in the prior art and other issues, support PUSCH transmission with three transmit ports, and/or improve a performance of uplink transmission.

FIG. 6 illustrates an example of a base station 700 according to an embodiment of the present disclosure. The base station 700 is configured to implement some embodiments of the disclosure. Some embodiments of the disclosure may be implemented into the base station 700 using any suitably configured hardware and/or software. The base station 700 may include a memory 701, a transceiver 702, and a processor 703 coupled to the memory 701 and the transceiver 702. The processor 703 may be configured to implement proposed functions, procedures and/or methods described in this description. Layers of radio interface protocol may be implemented in the processor 703. The memory 701 is operatively coupled with the processor 703 and stores a variety of information to operate the processor 703. The transceiver 702 is operatively coupled with the processor 703, and the transceiver 702 transmits and/or receives a radio signal. The processor 703 may include application-specific integrated circuit (ASIC), other chipset, logic circuit and/or data processing device. The memory 701 may include read-only memory (ROM), random access memory (RAM), flash memory, memory card, storage medium and/or other storage device. The transceiver 702 may include baseband circuitry to process radio frequency signals. When the embodiments are implemented in software, the techniques described herein can be implemented with modules (e.g., procedures, functions, and so on) that perform the functions described herein. The modules can be stored in the memory 701 and executed by the processor 703. The memory 701 can be implemented within the processor 703 or external to the processor 703 in which case those can be communicatively coupled to the processor 703 via various means as is known in the art.

In some embodiments, the base station 700 is reported by a user equipment (UE) that the UE supports three transmit ports for one PUSCH transmission and the base station 700 is configured to configure, to the UE, the one PUSCH transmission with the three transmit ports. This can solve issues in the prior art and other issues, support PUSCH transmission with three transmit ports, and/or improve a performance of uplink transmission.

FIG. 7 is an example of a method 800 of physical uplink shared channel (PUSCH) transmission with three transmit ports performed by a base station according to an embodiment of the present disclosure. The method 800 of physical uplink shared channel (PUSCH) transmission with three transmit ports performed by the base station is configured to implement some embodiments of the disclosure. Some embodiments of the disclosure may be implemented into the method 800 of physical uplink shared channel (PUSCH) transmission with three transmit ports performed by the base station using any suitably configured hardware and/or software. In some embodiments, the method 800 of physical uplink shared channel (PUSCH) transmission with three transmit ports performed by the base station includes: an operation 802, being reported by a user equipment (UE) that the UE supports three transmit ports for one PUSCH transmission, and an operation 804, configuring, to the UE, the one PUSCH transmission with the three transmit ports. This can solve issues in the prior art and other issues, support PUSCH transmission with three transmit ports, and/or improve a performance of uplink transmission.

In some embodiments, being reported by the UE that the UE supports the three transmit ports for the one PUSCH transmission includes reported by the UE in a UE capability reporting message that the UE supports the three transmit ports for the one PUSCH transmission. In some embodiments, the method further includes indicating the UE to transmit the one PUSCH transmission with the three transmit ports. In some embodiments, indicating the UE to transmit the one PUSCH transmission with the three transmit ports includes indicating the UE through a downlink control information (DCI) to transmit the one PUSCH transmission with the three transmit ports. In some embodiments, the method further includes indicating to the UE a number of layers for the one PUSCH transmission with the three transmit ports. In some embodiments, the number of layers is one layer, two layers, or three layers. In some embodiments, the method further includes indicating to the UE at least one transmit precoding matrix for the one PUSCH transmission with the three transmit ports.

In some embodiments, the base station is configured to indicate the UE to transmit the one PUSCH transmission with the three transmit ports, the one layer, and one of transmit precoding matrixes in a table 1:

TABLE 1

| TPMI | | | | | | | | |
|---|---|---|---|---|---|---|---|---|
| index | W | | | | | | | |
| 0-7 | $\frac{1}{\sqrt{3}} [ \begin{matrix}1 \\ 0 \\ 0\end{matrix} ]$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ | $\frac{1}{\sqrt{3}} [ \begin{matrix}1 \\ 1 \\ 0\end{matrix} ]$ | $\frac{1}{\sqrt{3}} [ \begin{matrix}1 \\ - 1 \\ 0\end{matrix} ]$ | $\frac{1}{\sqrt{3}} [ \begin{matrix}1 \\ j \\ 0\end{matrix} ]$ | $\frac{1}{\sqrt{3}} [ \begin{matrix}1 \\ - j \\ 0\end{matrix} ]$ | $\frac{1}{\sqrt{3}} [ \begin{matrix}1 \\ 0 \\ 1\end{matrix} ]$ |
| 8-15 | $\frac{1}{\sqrt{3}} [ \begin{matrix}1 \\ 0 \\ - 1\end{matrix} ]$ | $\frac{1}{\sqrt{3}} [ \begin{matrix}1 \\ 0 \\ - j\end{matrix} ]$ | $\frac{1}{\sqrt{3}} [ \begin{matrix}1 \\ 0 \\ j\end{matrix} ]$ | $\frac{1}{\sqrt{3}} [ \begin{matrix}1 \\ 1 \\ 1\end{matrix} ]$ | $\frac{1}{\sqrt{3}} [ \begin{matrix}1 \\ {e}^{- \frac{2 π j}{3}} \\ {e}^{- \frac{4 π j}{3}}\end{matrix} ]$ | $\frac{1}{\sqrt{3}} [ \begin{matrix}1 \\ {e}^{- \frac{4 π j}{3}} \\ {e}^{- \frac{8 π j}{3}}\end{matrix} ]$ | $\frac{1}{\sqrt{3}} [ \begin{matrix}1 \\ {e}^{\frac{2 π j}{3}} \\ 1\end{matrix} ]$ | $\frac{1}{\sqrt{3}} [ \begin{matrix}1 \\ 1 \\ {e}^{- \text{?}}\end{matrix} ]$ |
| 16-19 | $\frac{1}{\sqrt{3}} [ \begin{matrix}1 \\ {e}^{- \frac{2 π j}{3}} \\ {e}^{- \frac{8 π j}{3}}\end{matrix} ]$ | $\frac{1}{\sqrt{3}} [ \begin{matrix}1 \\ 1 \\ {e}^{\frac{2 π j}{3}}\end{matrix} ]$ | $\frac{1}{\sqrt{3}} [ \begin{matrix}1 \\ {e}^{- \frac{2 π j}{3}} \\ {e}^{- \frac{2 π j}{3}}\end{matrix} ]$ | $\frac{1}{\sqrt{3}} [ \begin{matrix}1 \\ {e}^{- \frac{4 π j}{3}} \\ 1\end{matrix} ]$ | | | | |

$\text{?} \text{indicates text missing or illegible when filed}$

wherein W is an order from left to right in an increasing order of a transmit precoding matrix

In some embodiments, the base station is configured to indicate the UE to transmit the one PUSCH transmission with the three transmit ports, the one layer, and one of transmit precoding matrixes in a table 2:

TABLE 2

| TPMI | | | | |
|---|---|---|---|---|
| index | W | | | |
| 0-3 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ | $\frac{1}{\sqrt{3}} [ \begin{matrix}1 & 0 \\ 0 & j \\ 0 & 0\end{matrix} ]$ |
| 4-7 | $\frac{1}{\sqrt{3}} [ \begin{matrix}1 & 0 \\ 0 & 0 \\ 0 & j\end{matrix} ]$ | $\frac{1}{\sqrt{3}} [ \begin{matrix}0 & 0 \\ 1 & 0 \\ 0 & j\end{matrix} ]$ | $\frac{1}{\sqrt{3}} [ \begin{matrix}1 & 0 \\ 0 & - j \\ 0 & 0\end{matrix} ]$ | $\frac{1}{\sqrt{3}} [ \begin{matrix}1 & 0 \\ 0 & 0 \\ 0 & - j\end{matrix} ]$ |
| 8-11 | $\frac{1}{\sqrt{3}} [ \begin{matrix}0 & 0 \\ 1 & 0 \\ 0 & - j\end{matrix} ]$ | $\frac{1}{\sqrt{6}} [ \begin{matrix}1 & 1 \\ 1 & {e}^{- \frac{2 π j}{3}} \\ 1 & {e}^{- \frac{4 π j}{3}}\end{matrix} ]$ | $\frac{1}{\sqrt{6}} [ \begin{matrix}1 & 1 \\ 1 & {e}^{- \frac{4 π j}{3}} \\ 1 & {e}^{- \frac{8 π j}{3}}\end{matrix} ]$ | $\frac{1}{\sqrt{6}} [ \begin{matrix}1 & 1 \\ {e}^{- \frac{2 π j}{3}} & {e}^{- \frac{4 π j}{3}} \\ {e}^{- \frac{4 π j}{3}} & {e}^{- \frac{8 π j}{3}}\end{matrix} ]$ |
| 12-15 | $\frac{1}{\sqrt{6}} [ \begin{matrix}1 & 1 \\ {e}^{\frac{2 π j}{3}} & 1 \\ 1 & {e}^{\frac{4 π j}{3}}\end{matrix} ]$ | $\frac{1}{\sqrt{6}} [ \begin{matrix}1 & 1 \\ {e}^{\frac{2 π j}{3}} & {e}^{- \frac{2 π j}{3}} \\ 1 & {e}^{- \frac{8 π j}{3}}\end{matrix} ]$ | $\frac{1}{\sqrt{6}} [ \begin{matrix}1 & 1 \\ 1 & {e}^{- \frac{2 π j}{3}} \\ {e}^{\frac{4 π j}{3}} & {e}^{- \frac{8 π j}{3}}\end{matrix} ]$ | $\frac{1}{\sqrt{6}} [ \begin{matrix}1 & 1 \\ 1 & {e}^{- \frac{2 π j}{3}} \\ {e}^{\frac{2 π j}{3}} & {e}^{- \frac{2 π j}{3}}\end{matrix} ]$ |
| 16-17 | $\frac{1}{\sqrt{6}} [ \begin{matrix}1 & 1 \\ 1 & {e}^{- \frac{4 π j}{3}} \\ {e}^{\frac{2 π j}{3}} & 1\end{matrix} ]$ | $\frac{1}{\sqrt{6}} [ \begin{matrix}1 & 1 \\ {e}^{- \frac{2 π j}{3}} & {e}^{- \frac{4 π j}{3}} \\ {e}^{- \frac{2 π j}{3}} & 1\end{matrix} ]$ | | |

wherein W is an order from left to right in an increasing order of a transmit precoding matrix indication (TPMI) index.

In some embodiments, the base station is configured to indicate the UE to transmit the one PUSCH transmission with the three transmit ports, the one layer, and one of transmit precoding matrixes in a table 3:

TABLE 3

| TPMI | | | |
|---|---|---|---|
| index | W | | |
| 0-2 | $\frac{1}{3} [ \begin{matrix}1 & 1 & 1 \\ 1 & {e}^{- \frac{2 π j}{3}} & {e}^{- \frac{4 π j}{3}} \\ 1 & {e}^{- \frac{4 π j}{3}} & {e}^{- \frac{8 π j}{3}}\end{matrix} ]$ | $\frac{1}{3} [ \begin{matrix}1 & 1 & 1 \\ {e}^{\frac{2 π j}{3}} & 1 & {e}^{- \frac{2 π j}{3}} \\ 1 & {e}^{- \frac{4 π j}{3}} & {e}^{- \frac{8 π j}{3}}\end{matrix} ]$ | $\frac{1}{3} [ \begin{matrix}1 & 1 & 1 \\ 1 & {e}^{- \frac{2 π j}{3}} & {e}^{- \frac{4 π j}{3}} \\ {e}^{\frac{2 π j}{3}} & {e}^{- \frac{2 π j}{3}} & 1\end{matrix} ]$ |

wherein W is an order from left to right in an increasing order of a transmit precoding matrix

### Exemplary Technical Solutions

In some embodiments, a UE can report that the UE can support three transmit ports for PUSCH transmission in UE capability reporting message to a system. The system may be a NR system or a base station. The system can configure PUSCH transmission with 3 transmit ports to the UE. For a UE configure with PUSCH transmission with 3 transmit ports, the UE can be requested to transmit a PUSCH with a single layer, two layers, or three layers. The base station such as a gNB can send one DCI to indicate the UE to transmit one PUSCH with 3 transmit ports and the gNB can indicate the number of layers and at least one transmit precoding matrix for the PUSCH transmission.

In one exemplary method, the gNB can send one DCI to indicate the UE to transmit one PUSCH with 3 transmit ports and one layer. The gNB can indicate to the UE to transmit the PUSCH with one of transmit precoding matrixes in Table 1:

TABLE 1
Transmit precoding matrix for one-layer transmission using 3 antenna ports

| TPMI | W | | | | | | | |
|---|---|---|---|---|---|---|---|---|
| Index | (Order from left to right in increasing order of TPMI index) | | | | | | | |
| 0-7 | $\frac{1}{\sqrt{3}} [ \text{?}$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ | $\frac{1}{\sqrt{3}} [ \begin{matrix}1 \\ 1 \\ 0\end{matrix} ]$ | $\frac{1}{\sqrt{3}} [ \begin{matrix}1 \\ - 1 \\ 0\end{matrix} ]$ | $\frac{1}{\sqrt{3}} [ \begin{matrix}1 \\ j \\ 0\end{matrix} ]$ | $\frac{1}{\sqrt{3}} [ \begin{matrix}1 \\ - j \\ 0\end{matrix} ]$ | $\frac{1}{\sqrt{3}} [ \begin{matrix}1 \\ 0 \\ 1\end{matrix} ]$ |
| 8-15 | $\frac{1}{\sqrt{3}} [ \text{?}$ | $\frac{1}{\sqrt{3}} [ \begin{matrix}1 \\ 0 \\ - j\end{matrix} ]$ | $\frac{1}{\sqrt{3}} [ \begin{matrix}1 \\ 0 \\ j\end{matrix} ]$ | $\frac{1}{\sqrt{3}} [ \begin{matrix}1 \\ 1 \\ 1\end{matrix} ]$ | $\frac{1}{\sqrt{3}} [ \begin{matrix}1 \\ {e}^{- \frac{2 π j}{3}} \\ {e}^{- \frac{4 π j}{3}}\end{matrix} ]$ | $\frac{1}{\sqrt{3}} [ \begin{matrix}1 \\ {e}^{- \frac{4 π j}{3}} \\ {e}^{- \frac{8 π j}{3}}\end{matrix} ]$ | $\frac{1}{\sqrt{3}} [ \begin{matrix}1 \\ {e}^{\frac{2 π j}{3}} \\ 1\end{matrix} ]$ | $\frac{1}{\sqrt{3}} [ \begin{matrix}1 \\ 1 \\ {e}^{- \frac{4 π j}{3}}\end{matrix} ]$ |
| 16-19 | $\frac{1}{\sqrt{3}} [ \text{?}$ | $\frac{1}{\sqrt{3}} [ \begin{matrix}1 \\ 1 \\ {e}^{\frac{2 π j}{3}}\end{matrix} ]$ | $\frac{1}{\sqrt{3}} [ \begin{matrix}1 \\ {e}^{- \frac{2 π j}{3}} \\ {e}^{- \frac{2 π j}{3}}\end{matrix} ]$ | $\frac{1}{\sqrt{3}} [ \begin{matrix}1 \\ {e}^{- \frac{4 π j}{3}} \\ 1\end{matrix} ]$ | | | | |

$\text{?} \text{indicates text missing or illegible when filed}$

In one exemplary method, the gNB can send one DCI to indicate the UE to transmit one PUSCH with 3 Tx ports and two layers. The gNB can indicate to the UE to transmit the PUSCH with one of transmit precoding matrixes in Table 2:

TABLE 2
Transmit precoding matrix for two-layer transmission using 3 antenna ports

| TPMI | W | | | |
|---|---|---|---|---|
| Index | (Order from left to right in increasing order of TPMI index) | | | |
| 0-3 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ | $\frac{1}{\sqrt{3}} [ \begin{matrix}1 & 0 \\ 0 & j \\ 0 & 0\end{matrix} ]$ |
| 4-7 | $\frac{1}{\sqrt{3}} [ \begin{matrix}1 & 0 \\ 0 & 0 \\ 0 & j\end{matrix} ]$ | $\frac{1}{\sqrt{3}} [ \begin{matrix}0 & 0 \\ 1 & 0 \\ 0 & j\end{matrix} ]$ | $\frac{1}{\sqrt{3}} [ \begin{matrix}1 & 0 \\ 0 & - j \\ 0 & 0\end{matrix} ]$ | $\frac{1}{\sqrt{3}} [ \begin{matrix}1 & 0 \\ 0 & 0 \\ 0 & - j\end{matrix} ]$ |
| 8-11 | $\frac{1}{\sqrt{3}} [ \begin{matrix}0 & 0 \\ 1 & 0 \\ 0 & - j\end{matrix} ]$ | $\frac{1}{\sqrt{6}} [ \begin{matrix}1 & 1 \\ 1 & {e}^{- \frac{2 π j}{3}} \\ 1 & {e}^{- \frac{4 π j}{3}}\end{matrix} ]$ | $\frac{1}{\sqrt{6}} [ \begin{matrix}1 & 1 \\ 1 & {e}^{- \frac{4 π j}{3}} \\ 1 & {e}^{- \frac{8 π j}{3}}\end{matrix} ]$ | $\frac{1}{\sqrt{6}} [ \begin{matrix}1 & 1 \\ {e}^{- \frac{2 π j}{3}} & {e}^{- \frac{4 π j}{3}} \\ {e}^{- \frac{4 π j}{3}} & {e}^{- \frac{8 π j}{3}}\end{matrix} ]$ |
| 12-15 | $\frac{1}{\sqrt{6}} [ \begin{matrix}1 & 1 \\ {e}^{\frac{2 π j}{3}} & 1 \\ 1 & {e}^{\frac{4 π j}{3}}\end{matrix} ]$ | $\frac{1}{\sqrt{6}} [ \begin{matrix}1 & 1 \\ {e}^{\frac{2 π j}{3}} & {e}^{- \frac{2 π j}{3}} \\ 1 & {e}^{- \frac{8 π j}{3}}\end{matrix} ]$ | $\frac{1}{\sqrt{6}} [ \begin{matrix}1 & 1 \\ 1 & {e}^{- \frac{2 π j}{3}} \\ {e}^{\frac{4 π j}{3}} & {e}^{- \frac{8 π j}{3}}\end{matrix} ]$ | $\frac{1}{\sqrt{6}} [ \begin{matrix}1 & 1 \\ 1 & {e}^{- \frac{2 π j}{3}} \\ {e}^{\frac{2 π j}{3}} & {e}^{- \frac{2 π j}{3}}\end{matrix} ]$ |
| 16-17 | $\frac{1}{\sqrt{6}} [ \begin{matrix}1 & 1 \\ 1 & {e}^{- \frac{4 π j}{3}} \\ {e}^{\frac{2 π j}{3}} & 1\end{matrix} ]$ | $\frac{1}{\sqrt{6}} [ \begin{matrix}1 & 1 \\ {e}^{- \frac{2 π j}{3}} & {e}^{- \frac{4 π j}{3}} \\ {e}^{- \frac{2 π j}{3}} & 1\end{matrix} ]$ | | |

In one exemplary method, the gNB can send one DCI to indicate the UE to transmit one PUSCH with 3 Tx ports and three layers. The gNB can indicate to the UE to transmit the PUSCH with one of transmit precoding matrixes in Table 3:

TABLE 3
Transmit precoding matrixes for three-layer transmission using 3 antenna ports

| TPMI | W | | |
|---|---|---|---|
| Index | (Order from left to right in increasing order of TPMI index) | | |
| 0-2 | $\frac{1}{3} [ \begin{matrix}1 & 1 & 1 \\ 1 & {e}^{- \frac{2 π j}{3}} & {e}^{- \frac{4 π j}{3}} \\ 1 & {e}^{- \frac{4 π j}{3}} & {e}^{- \frac{8 π j}{3}}\end{matrix} ]$ | $\frac{1}{3} [ \begin{matrix}1 & 1 & 1 \\ {e}^{\frac{2 π j}{3}} & 1 & {e}^{- \frac{2 π j}{3}} \\ 1 & {e}^{- \frac{4 π j}{3}} & {e}^{- \frac{8 π j}{3}}\end{matrix} ]$ | $\frac{1}{3} [ \begin{matrix}1 & 1 & 1 \\ 1 & {e}^{- \frac{2 π j}{3}} & {e}^{- \frac{4 π j}{3}} \\ {e}^{\frac{2 π j}{3}} & {e}^{- \frac{2 π j}{3}} & 1\end{matrix} ]$ |

With the above some embodiments, the NR system can support PUSCH transmission with three transmit ports with optimized design and thus a performance of uolink transmission is improved.

Commercial interests for some embodiments are as follows. 1. Solve issues in the prior art and other issues. 2. Support PUSCH transmission with three transmit ports. 3. Improve a performance of uplink transmission. 4. Provide a good communication performance. 5. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of physical uplink shared channel (PUSCH) transmission with three transmit ports are considered for standardizing.

FIG. 8 is an example of a computing device 1100 according to an embodiment of the present disclosure. Any suitable computing device can be used for performing the operations described herein. For example, FIG. 8 illustrates an example of the computing device 1100 that can implement some embodiments of FIG. 1 to FIG. 7 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

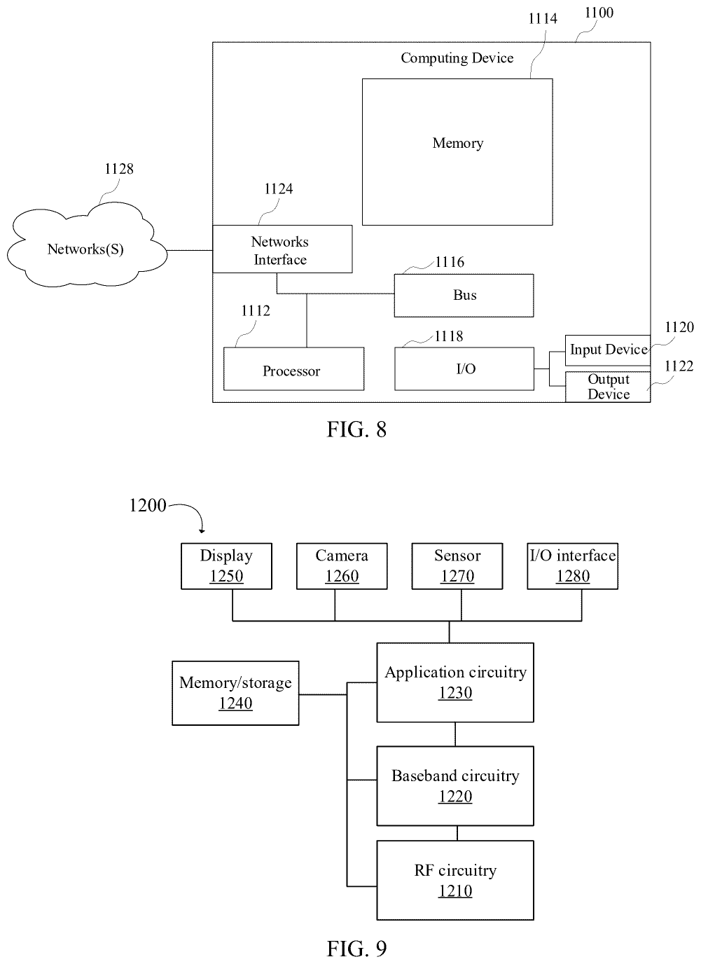

FIG. 9 is a block diagram of an example of a communication system 1200 according to an embodiment of the present disclosure. Embodiments described herein may be implemented into the communication system 1200 using any suitably configured hardware and/or software. FIG. 9 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1 to FIG. 7. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using u modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1 to FIG. 7 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of physical uplink shared channel (PUSCH) transmission with three transmit ports, by a user equipment (UE), comprising:
reporting to a base station that the UE supports three transmit ports for one PUSCH transmission; and
being configured by the base station with the one PUSCH transmission with the three transmit ports.

2. The method of claim 1, wherein reporting to the base station that the UE supports the three transmit ports for the one PUSCH transmission comprises:
reporting to the base station in a UE capability reporting message that the UE supports the three transmit ports for the one PUSCH transmission.

3. The method of claim 1, further comprising being indicated by the base station to transmit the one PUSCH transmission with the three transmit ports.

4. The method of claim 3, wherein being indicated by the base station to transmit the one PUSCH transmission with the three transmit ports comprises: being indicated by the base station through a downlink control information (DCI) to transmit the one PUSCH transmission with the three transmit ports.

5. The method of claim 3, further comprising being indicated by the base station with a number of layers for the one PUSCH transmission with the three transmit ports.

6. The method of claim 5, wherein the number of layers is one layer, two layers, or three layers.

7. The method of claim 3, further comprising being indicated by the base station with at least one transmit precoding matrix for the one PUSCH transmission with the three transmit ports.

8. The method of claim 7, wherein the UE is indicated to transmit the one PUSCH transmission with the three transmit ports, the one layer, and one of transmit precoding matrixes in a table 1:

| TPMI index | W | | | | | | | |
|---|---|---|---|---|---|---|---|---|
| 0-7 | $\frac{1}{\sqrt{3}} [ \begin{matrix}1 \\ 0 \\ 0\end{matrix} ]$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ | $\frac{1}{\sqrt{3}} [ \begin{matrix}1 \\ 1 \\ 0\end{matrix} ]$ | $\frac{1}{\sqrt{3}} [ \begin{matrix}1 \\ - 1 \\ 0\end{matrix} ]$ | $\frac{1}{\sqrt{3}} [ \begin{matrix}1 \\ j \\ 0\end{matrix} ]$ | $\frac{1}{\sqrt{3}} [ \begin{matrix}1 \\ - j \\ 0\end{matrix} ]$ | $\frac{1}{\sqrt{3}} [ \begin{matrix}1 \\ 0 \\ 1\end{matrix} ]$ |
| 8-15 | $\frac{1}{\sqrt{3}} [ \begin{matrix}1 \\ 0 \\ - 1\end{matrix} ]$ | $\frac{1}{\sqrt{3}} [ \begin{matrix}1 \\ 0 \\ - j\end{matrix} ]$ | $\frac{1}{\sqrt{3}} [ \begin{matrix}1 \\ 0 \\ j\end{matrix} ]$ | $\frac{1}{\sqrt{3}} [ \begin{matrix}1 \\ 1 \\ 1\end{matrix} ]$ | $\frac{1}{\sqrt{3}} [ \begin{matrix}1 \\ {e}^{- \frac{2 π j}{3}} \\ {e}^{- \frac{4 π j}{3}}\end{matrix} ]$ | $\frac{1}{\sqrt{3}} [ \begin{matrix}1 \\ {e}^{- \frac{4 π j}{3}} \\ {e}^{- \frac{8 π j}{3}}\end{matrix} ]$ | $\frac{1}{\sqrt{3}} [ \begin{matrix}1 \\ {e}^{\frac{2 π j}{3}} \\ 1\end{matrix} ]$ | $\frac{1}{\sqrt{3}} [ \begin{matrix}1 \\ 1 \\ {e}^{- \text{?}}\end{matrix} ]$ |
| 16-19 | $\frac{1}{\sqrt{3}} [ \begin{matrix}1 \\ {e}^{- \frac{2 π j}{3}} \\ {e}^{- \frac{8 π j}{3}}\end{matrix} ]$ | $\frac{1}{\sqrt{3}} [ \begin{matrix}1 \\ 1 \\ {e}^{\frac{2 π j}{3}}\end{matrix} ]$ | $\frac{1}{\sqrt{3}} [ \begin{matrix}1 \\ {e}^{- \frac{2 π j}{3}} \\ {e}^{- \frac{2 π j}{3}}\end{matrix} ]$ | $\frac{1}{\sqrt{3}} [ \begin{matrix}1 \\ {e}^{- \frac{4 π j}{3}} \\ 1\end{matrix} ]$ | | | | |

$\text{?} \text{indicates text missing or illegible when filed}$
wherein W is an order from left to right in an increasing order of a transmit precoding matrix

9. The method of claim 7, wherein the UE is indicated to transmit the one PUSCH transmission with the three transmit ports, the one layer, and one of transmit precoding matrixes in a table 2:

| TPMI index | W | | | |
|---|---|---|---|---|
| 0-3 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ | $\frac{1}{\sqrt{3}} [ \begin{matrix}1 & 0 \\ 0 & j \\ 0 & 0\end{matrix} ]$ |
| 4-7 | $\frac{1}{\sqrt{3}} [ \begin{matrix}1 & 0 \\ 0 & 0 \\ 0 & j\end{matrix} ]$ | $\frac{1}{\sqrt{3}} [ \begin{matrix}0 & 0 \\ 1 & 0 \\ 0 & j\end{matrix} ]$ | $\frac{1}{\sqrt{3}} [ \begin{matrix}1 & 0 \\ 0 & - j \\ 0 & 0\end{matrix} ]$ | $\frac{1}{\sqrt{3}} [ \begin{matrix}1 & 0 \\ 0 & 0 \\ 0 & - j\end{matrix} ]$ |
| 8-11 | $\frac{1}{\sqrt{3}} [ \begin{matrix}0 & 0 \\ 1 & 0 \\ 0 & - j\end{matrix} ]$ | $\frac{1}{\sqrt{6}} [ \begin{matrix}1 & 1 \\ 1 & {e}^{- \frac{2 π j}{3}} \\ 1 & {e}^{- \frac{4 π j}{3}}\end{matrix} ]$ | $\frac{1}{\sqrt{6}} [ \begin{matrix}1 & 1 \\ 1 & {e}^{- \frac{4 π j}{3}} \\ 1 & {e}^{- \frac{8 π j}{3}}\end{matrix} ]$ | $\frac{1}{\sqrt{6}} [ \begin{matrix}1 & 1 \\ {e}^{- \frac{2 π j}{3}} & {e}^{- \frac{4 π j}{3}} \\ {e}^{- \frac{4 π j}{3}} & {e}^{- \frac{8 π j}{3}}\end{matrix} ]$ |
| 12-15 | $\frac{1}{\sqrt{6}} [ \begin{matrix}1 & 1 \\ {e}^{\frac{2 π j}{3}} & 1 \\ 1 & {e}^{\frac{4 π j}{3}}\end{matrix} ]$ | $\frac{1}{\sqrt{6}} [ \begin{matrix}1 & 1 \\ {e}^{\frac{2 π j}{3}} & {e}^{- \frac{2 π j}{3}} \\ 1 & {e}^{- \frac{8 π j}{3}}\end{matrix} ]$ | $\frac{1}{\sqrt{6}} [ \begin{matrix}1 & 1 \\ 1 & {e}^{- \frac{2 π j}{3}} \\ {e}^{\frac{4 π j}{3}} & {e}^{- \frac{8 π j}{3}}\end{matrix} ]$ | $\frac{1}{\sqrt{6}} [ \begin{matrix}1 & 1 \\ 1 & {e}^{- \frac{2 π j}{3}} \\ {e}^{\frac{2 π j}{3}} & {e}^{- \frac{2 π j}{3}}\end{matrix} ]$ |
| 16-17 | $\frac{1}{\sqrt{6}} [ \begin{matrix}1 & 1 \\ 1 & {e}^{- \frac{4 π j}{3}} \\ {e}^{\frac{2 π j}{3}} & 1\end{matrix} ]$ | $\frac{1}{\sqrt{6}} [ \begin{matrix}1 & 1 \\ {e}^{- \frac{2 π j}{3}} & {e}^{- \frac{4 π j}{3}} \\ {e}^{- \frac{2 π j}{3}} & 1\end{matrix} ]$ | | |

wherein W is an order from left to right in an increasing order of a transmit precoding matrix indication (TPMI) index.

10. The method of claim 7, wherein the UE is indicated to transmit the one PUSCH transmission with the three transmit ports, the one layer, and one of transmit precoding matrixes in a table 3:

| TPMI index | W | | |
|---|---|---|---|
| 0-2 | $\frac{1}{3} [ \begin{matrix}1 & 1 & 1 \\ 1 & {e}^{- \frac{2 π j}{3}} & {e}^{- \frac{4 π j}{3}} \\ 1 & {e}^{- \frac{4 π j}{3}} & {e}^{- \frac{8 π j}{3}}\end{matrix} ]$ | $\frac{1}{3} [ \begin{matrix}1 & 1 & 1 \\ {e}^{\frac{2 π j}{3}} & 1 & {e}^{- \frac{2 π j}{3}} \\ 1 & {e}^{- \frac{4 π j}{3}} & {e}^{- \frac{8 π j}{3}}\end{matrix} ]$ | $\frac{1}{3} [ \begin{matrix}1 & 1 & 1 \\ 1 & {e}^{- \frac{2 π j}{3}} & {e}^{- \frac{4 π j}{3}} \\ {e}^{\frac{2 π j}{3}} & {e}^{- \frac{2 π j}{3}} & 1\end{matrix} ]$ |

wherein W is an order from left to right in an increasing order of a transmit precoding matrix indication (TPMI) index.

11. A method of physical uplink shared channel (PUSCH) transmission with three transmit ports, by a base station, comprising:
being reported by a user equipment (UE) that the UE supports three transmit ports for one PUSCH transmission; and
configuring, to the UE, the one PUSCH transmission with the three transmit ports.

12. The method of claim 11, wherein being reported by the UE that the UE supports the three transmit ports for the one PUSCH transmission comprises:
reported by the UE in a UE capability reporting message that the UE supports the three transmit ports for the one PUSCH transmission.

13. The method of claim 11, further comprising indicating the UE to transmit the one PUSCH transmission with the three transmit ports.

14. The method of claim 13, wherein indicating the UE to transmit the one PUSCH transmission with the three transmit ports comprises:
indicating the UE through a downlink control information (DCI) to transmit the one PUSCH transmission with the three transmit ports.

15. The method of claim 13, further comprising indicating to the UE a number of layers for the one PUSCH transmission with the three transmit ports.

16. The method of claim 15, wherein the number of layers is one layer, two layers, or three layers.

17. The method of claim 13, further comprising indicating to the UE at least one transmit precoding matrix for the one PUSCH transmission with the three transmit ports.

18. The method of claim 17, wherein the base station is configured to indicate the UE to transmit the one PUSCH transmission with the three transmit ports, the one layer, and one of transmit precoding matrixes in a table 1:

| TPMI index | W | | | | | | | |
|---|---|---|---|---|---|---|---|---|
| 0-7 | $\frac{1}{\sqrt{3}} [ \begin{matrix}1 \\ 0 \\ 0\end{matrix} ]$ | $\frac{1}{\sqrt{3}} [ \begin{matrix}0 \\ 1 \\ 0\end{matrix} ]$ | $\frac{1}{\sqrt{3}} [ \begin{matrix}0 \\ 0 \\ 1\end{matrix} ]$ | $\frac{1}{\sqrt{3}} [ \begin{matrix}1 \\ 1 \\ 0\end{matrix} ]$ | $\frac{1}{\sqrt{3}} [ \begin{matrix}1 \\ - 1 \\ 0\end{matrix} ]$ | $\frac{1}{\sqrt{3}} [ \begin{matrix}1 \\ j \\ 0\end{matrix} ]$ | $\frac{1}{\sqrt{3}} [ \begin{matrix}1 \\ - j \\ 0\end{matrix} ]$ | $\frac{1}{\sqrt{3}} [ \begin{matrix}1 \\ 0 \\ 1\end{matrix} ]$ |
| 8-15 | $\frac{1}{\sqrt{3}} [ \begin{matrix}1 \\ 0 \\ - 1\end{matrix} ]$ | $\frac{1}{\sqrt{3}} [ \begin{matrix}1 \\ 0 \\ - j\end{matrix} ]$ | $\frac{1}{\sqrt{3}} [ \begin{matrix}1 \\ 0 \\ j\end{matrix} ]$ | $\frac{1}{\sqrt{3}} [ \begin{matrix}1 \\ 1 \\ 1\end{matrix} ]$ | $\frac{1}{\sqrt{3}} [ \begin{matrix}1 \\ {e}^{- \frac{2 π j}{3}} \\ {e}^{- \frac{4 π j}{3}}\end{matrix} ]$ | $\frac{1}{\sqrt{3}} [ \begin{matrix}1 \\ {e}^{- \frac{4 π j}{3}} \\ {e}^{- \frac{8 π j}{3}}\end{matrix} ]$ | $\frac{1}{\sqrt{3}} [ \begin{matrix}1 \\ {e}^{\frac{2 π j}{3}} \\ 1\end{matrix} ]$ | $\frac{1}{\sqrt{3}} [ \begin{matrix}1 \\ 1 \\ {e}^{- \text{?}}\end{matrix} ]$ |
| 16-19 | $\frac{1}{\sqrt{3}} [ \begin{matrix}1 \\ {e}^{- \frac{2 π j}{3}} \\ {e}^{- \frac{8 π j}{3}}\end{matrix} ]$ | $\frac{1}{\sqrt{3}} [ \begin{matrix}1 \\ 1 \\ {e}^{\frac{2 π j}{3}}\end{matrix} ]$ | $\frac{1}{\sqrt{3}} [ \begin{matrix}1 \\ {e}^{- \frac{2 π j}{3}} \\ {e}^{- \frac{2 π j}{3}}\end{matrix} ]$ | $\frac{1}{\sqrt{3}} [ \begin{matrix}1 \\ {e}^{- \frac{4 π j}{3}} \\ 1\end{matrix} ]$ | | | | |

$\text{?} \text{indicates text missing or illegible when filed}$
wherein W is an order from left to right in an increasing order of a transmit precoding matrix indication (TPMI) index.

19. The method of claim 17, wherein the base station is configured to indicate the UE to transmit the one PUSCH transmission with the three transmit ports, the one layer, and one of transmit precoding matrixes in a table 2:

| TPMI index | W | | | |
|---|---|---|---|---|
| 0-3 | $\frac{1}{\sqrt{3}} [ \begin{matrix}1 & 0 \\ 0 & 1 \\ 0 & 0\end{matrix} ]$ | $\frac{1}{\sqrt{3}} [ \begin{matrix}1 & 0 \\ 0 & 0 \\ 0 & 1\end{matrix} ]$ | $\frac{1}{\sqrt{3}} [ \begin{matrix}0 & 0 \\ 1 & 0 \\ 0 & 1\end{matrix} ]$ | $\frac{1}{\sqrt{3}} [ \begin{matrix}1 & 0 \\ 0 & j \\ 0 & 0\end{matrix} ]$ |
| 4-7 | $\frac{1}{\sqrt{3}} [ \begin{matrix}1 & 0 \\ 0 & 0 \\ 0 & j\end{matrix} ]$ | $\frac{1}{\sqrt{3}} [ \begin{matrix}0 & 0 \\ 1 & 0 \\ 0 & j\end{matrix} ]$ | $\frac{1}{\sqrt{3}} [ \begin{matrix}1 & 0 \\ 0 & - j \\ 0 & 0\end{matrix} ]$ | $\frac{1}{\sqrt{3}} [ \begin{matrix}1 & 0 \\ 0 & 0 \\ 0 & - j\end{matrix} ]$ |
| 8-11 | $\frac{1}{\sqrt{3}} [ \begin{matrix}0 & 0 \\ 1 & 0 \\ 0 & - j\end{matrix} ]$ | $\frac{1}{\sqrt{6}} [ \begin{matrix}1 & 1 \\ 1 & {e}^{- \frac{2 π j}{3}} \\ 1 & {e}^{- \frac{4 π j}{3}}\end{matrix} ]$ | $\frac{1}{\sqrt{6}} [ \begin{matrix}1 & 1 \\ 1 & {e}^{- \frac{4 π j}{3}} \\ 1 & {e}^{- \frac{8 π j}{3}}\end{matrix} ]$ | $\frac{1}{\sqrt{6}} [ \begin{matrix}1 & 1 \\ {e}^{- \frac{2 π j}{3}} & {e}^{- \frac{4 π j}{3}} \\ {e}^{- \frac{4 π j}{3}} & {e}^{- \frac{8 π j}{3}}\end{matrix} ]$ |
| 12-15 | $\frac{1}{\sqrt{6}} [ \begin{matrix}1 & 1 \\ {e}^{\frac{2 π j}{3}} & 1 \\ 1 & {e}^{\frac{4 π j}{3}}\end{matrix} ]$ | $\frac{1}{\sqrt{6}} [ \begin{matrix}1 & 1 \\ {e}^{\frac{2 π j}{3}} & {e}^{- \frac{2 π j}{3}} \\ 1 & {e}^{- \frac{8 π j}{3}}\end{matrix} ]$ | $\frac{1}{\sqrt{6}} [ \begin{matrix}1 & 1 \\ 1 & {e}^{- \frac{2 π j}{3}} \\ {e}^{\frac{4 π j}{3}} & {e}^{- \frac{8 π j}{3}}\end{matrix} ]$ | $\frac{1}{\sqrt{6}} [ \begin{matrix}1 & 1 \\ 1 & {e}^{- \frac{2 π j}{3}} \\ {e}^{\frac{2 π j}{3}} & {e}^{- \frac{2 π j}{3}}\end{matrix} ]$ |
| 16-17 | $\frac{1}{\sqrt{6}} [ \begin{matrix}1 & 1 \\ 1 & {e}^{- \frac{4 π j}{3}} \\ {e}^{\frac{2 π j}{3}} & 1\end{matrix} ]$ | $\frac{1}{\sqrt{6}} [ \begin{matrix}1 & 1 \\ {e}^{- \frac{2 π j}{3}} & {e}^{- \frac{4 π j}{3}} \\ {e}^{- \frac{2 π j}{3}} & 1\end{matrix} ]$ | | |

wherein W is an order from left to right in an increasing order of a transmit precoding matrix

20. A user equipment (UE), comprising:
a memory;
a transceiver; and
a processor coupled to the memory and the transceiver;
wherein the UE is configured to:
report to a base station that the UE supports three transmit ports for one PUSCH transmission; and
be configured by the base station with the one PUSCH transmission with the three transmit ports.
